(19) United States
(12) Patent Application Publication
(10) Pub. No.: US 2011/0206956 A1
(43) Pub. Date: Aug. 25, 2011

(54) ROUND CELL BATTERY

(75) Inventors: William Lonzo Woods, JR., Kaufman, TX (US); Scott Edward Leonard, Rockwall, TX (US)

(73) Assignee: Lineage Power Corporation, Plano, TX (US)

(21) Appl. No.: 12/827,078

(22) Filed: Jun. 30, 2010

Related U.S. Application Data
(60) Provisional application No. 61/306,781, filed on Feb. 22, 2010.

(51) Int. Cl. H01M 2/12; H01M 4/72; H01M 4/82

(52) U.S. Cl. 429/53; 429/233; 29/2

(57) ABSTRACT

A round cell battery comprising a stack of substantially cylindrically-shaped electrically conductive grid plates and two or more bus bars. One or more of the bus bars is electrically connected to outer rims of a set of alternating ones of the grid plates in the stack and to a positive voltage post of the battery. A different one or more of the bus bars is electrically connected to outer rims of a different set of alternate ones of the grid plates in the stack and to a negative voltage post of the battery.

### CROSS-REFERENCE TO RELATED APPLICATION

This application claims the benefit of U.S. Provisional Application Ser. No. 61/306,781, filed by William Lonzo Woods Jr, et al. on Feb. 22, 2010, entitled “LEAD ACID BATTERY,” commonly assigned with this application and incorporated herein by reference.

### TECHNICAL FIELD

This application is directed, in general, to batteries and, more specifically, to a round cell battery and its method of assembly.

### BACKGROUND

This section introduces aspects that may be helpful to facilitating a better understanding of the inventions. Accordingly, the statements of this section are to be read in this light. The statements of this section are not to be understood as admissions about what is in the prior art or what is not in the prior art.

Round cell batteries, such as round cell lead acid batteries, have been in use for many years, e.g., at telecommunication sites as a source of reliable reserve power, and have demonstrated excellent performance characteristics and long life. However, certain traditional round cell battery designs can have a large number of unique parts and therefore require a large number of manufacturing steps to prepare the battery's different component parts. This, in turn, can increase the time and cost to manufacture the battery.

It would be beneficial to have round cell battery design that retains the performance characteristics and longevity of traditional round cell battery designs, but use a simpler design with fewer parts and simpler assembly, to thereby reduced labor and material costs.

### SUMMARY

One embodiment provides a round cell battery. The battery comprises a stack of substantially cylindrically-shaped electrically conductive grid plates and two or more bus bars. One or more of the bus bars is electrically connected to outer rims of a set of alternating ones of the grid plates in the stack and to a positive voltage post of the battery. A different one or more of the bus bars is electrically connected to outer rims of a different set of alternate ones of the grid plates in the stack and to a negative voltage post of the battery.

Another embodiment provides a method of assembling the above-described battery. The method comprises forming the stack of the substantially cylindrically-shaped electrically conductive grid plates and connecting the two or more bus bars to the outer rims of the grid plates. The method also comprises coupling the one or more bus bars to the positive voltage post and coupling the different one or more bus bars to the negative voltage post.

### BRIEF DESCRIPTION

Embodiments of the disclosure are better understood from the following detailed description, when read with the accompanying FIGUREs. Corresponding or like numbers or characters indicate corresponding or like structures. Various features may not be drawn to scale and may be arbitrarily increased or reduced in size for clarity of discussion. Reference is now made to the following descriptions taken in conjunction with the accompanying drawings, in which:

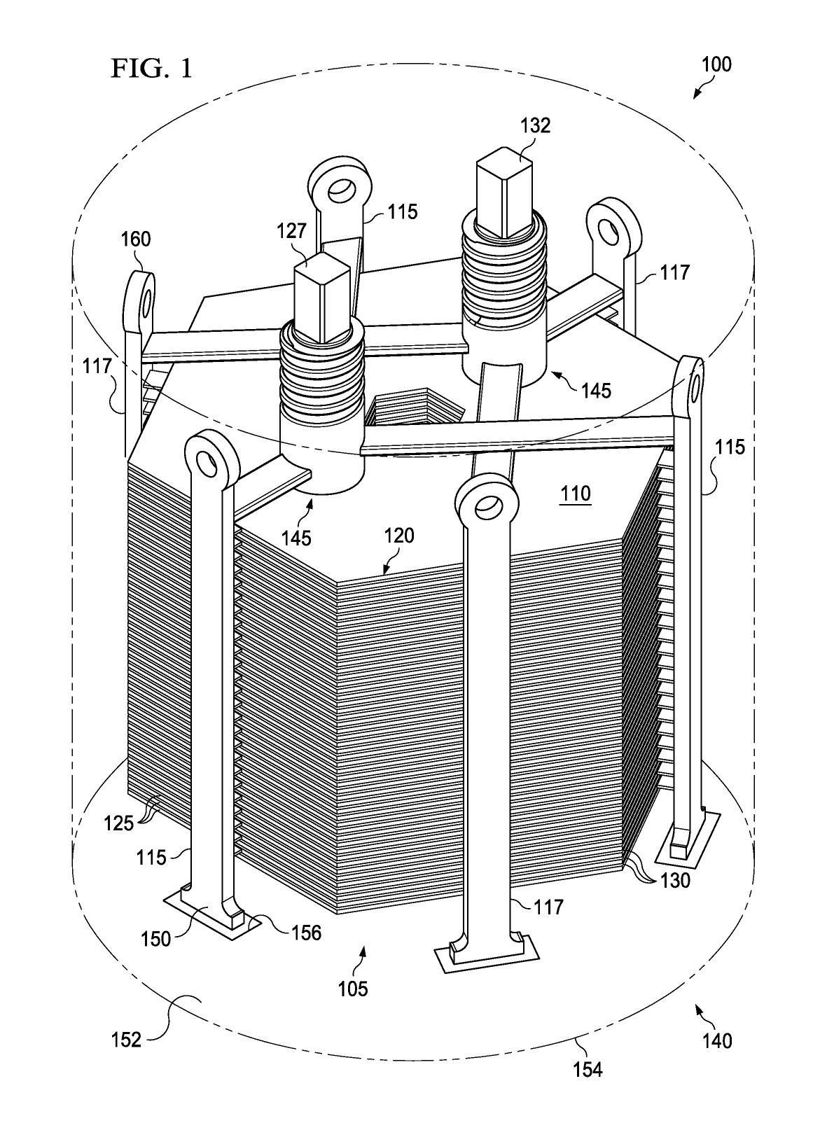

FIG. 1 presents a perspective view of an example embodiment of a round cell battery of the disclosure;

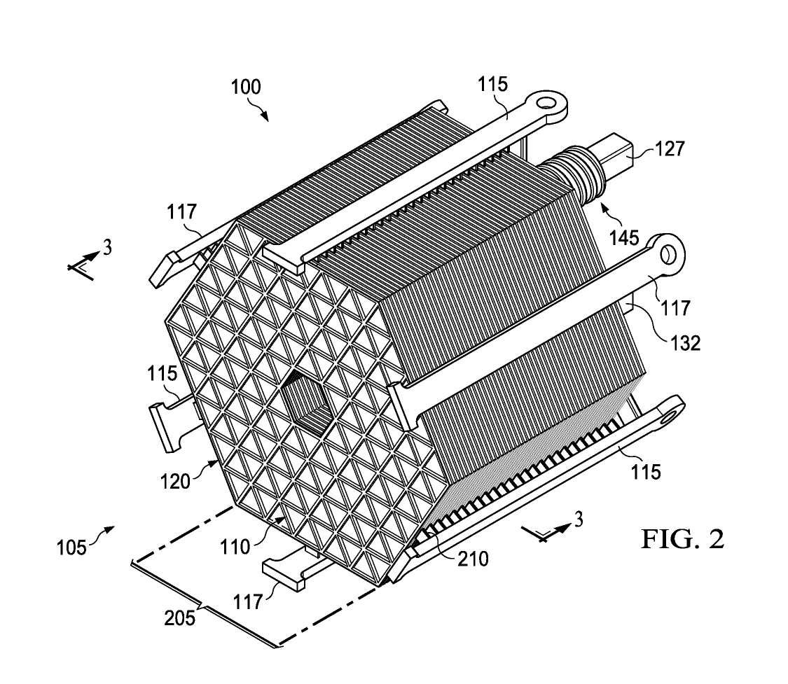

FIG. 2 presents a different perspective view of the example embodiment of the round cell battery presented in FIG. 1;

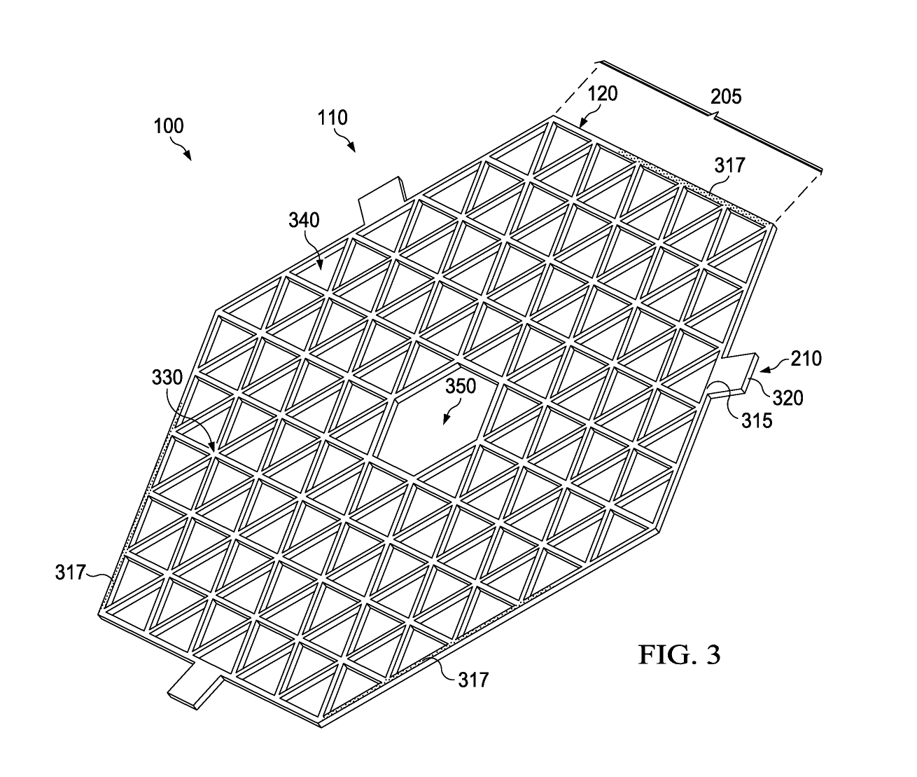

FIG. 3 presents a cross-sectional view of an example grid plate of the round cell battery such as presented in FIGS. 1-2, along view line 3-3 in FIG. 2;

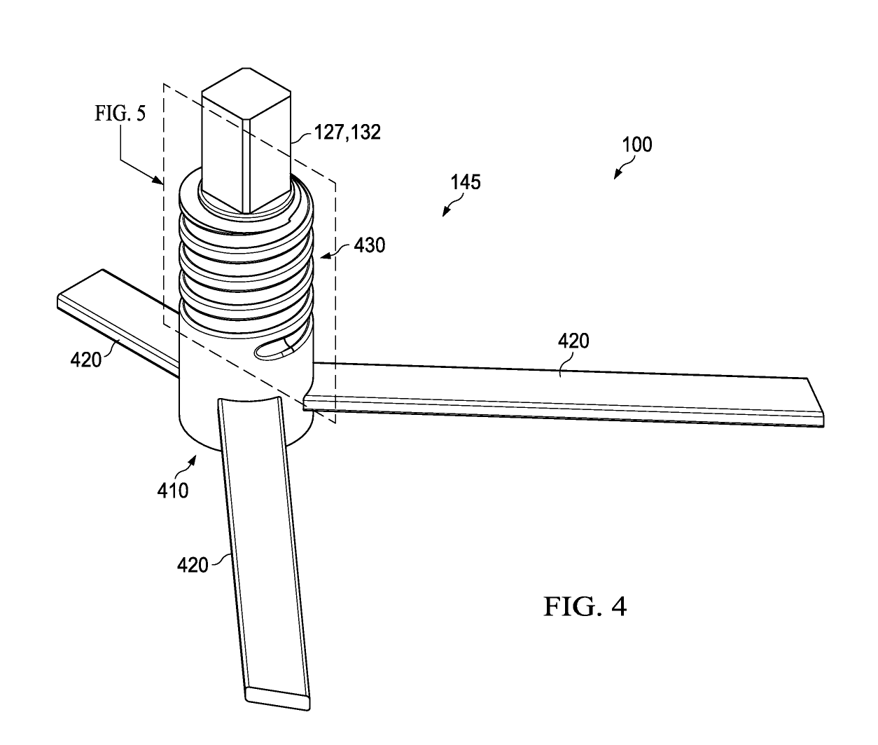

FIG. 4 shows a detailed perspective view of a multi-armed assembly of the battery such as depicted in FIG. 1;

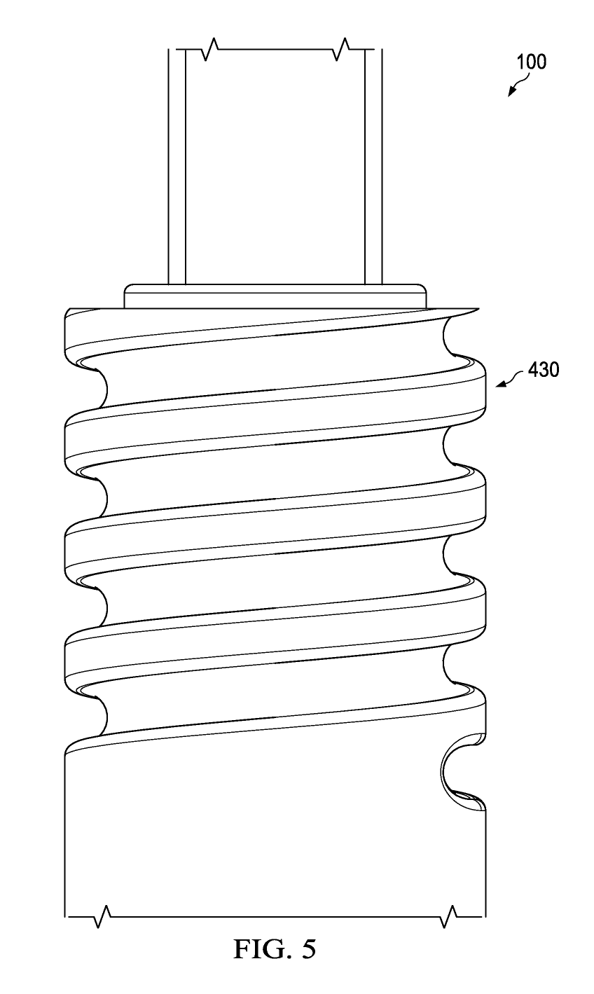

FIG. 5 shows a detailed perspective view of a helical labyrinth portion of the multi-armed assembly corresponding to view 5 in FIG. 4;

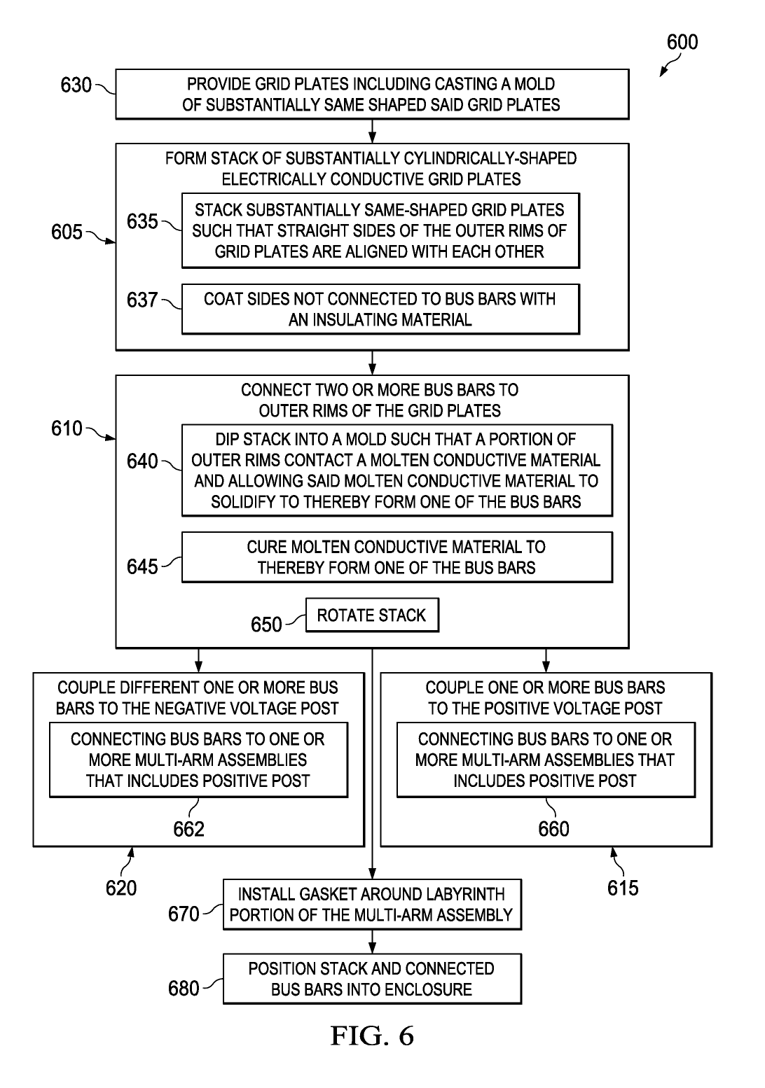

FIG. 6 presents a flow diagram of an example embodiment of a method of assembling a round cell battery of the disclosure, such as any of the example batteries depicted in FIGS. 1-5.

### DETAILED DESCRIPTION

The following merely illustrate principles of the invention. Those skilled in the art will appreciate the ability to devise various arrangements which, although not explicitly described or shown herein, embody the principles of the invention and are included within its scope. Furthermore, all examples and conditional language recited herein are principally intended expressly to be only for pedagogical purposes to aid in understanding the principles of the invention and the concepts contributed by the inventor(s) to furthering the art, and are to be construed as being without limitation to specifically disclosed embodiments and conditions. Moreover, all statements herein reciting principles, aspects, and embodiments of the invention, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

One embodiment is a round-cell battery. FIG. 1 presents a perspective view of an example embodiment of a round cell battery 100 of the disclosure and FIG. 2 presents a different perspective view of the example round cell battery 100 presented in FIG. 1. The battery 100 comprises a stack 105 of substantially cylindrically-shaped electrically conductive grid plates 110. The battery 100 also comprises two or more bus bars 115, 117. One or more of the bus bars 115 is electrically connected to outer rims 120 of a set 125 of alternating ones of the grid plates 110 in the stack 105 and to a positive voltage post 127 of the battery 100. A different one or more of the bus bars 117 is electrically connected to outer rims 120 of a different set 130 of alternate ones of the grid plates 110 in the stack 105 and to a negative voltage post 132 of the battery.

For instance, for the example battery shown in FIG. 1, the outer rims 120 the set 125 of even-numbered the grid plates 110 can be connected to one or more bus bars 115, and, outer rims 120 of the set 130 of odd-numbered the grid plates 110 can be connected to a different one or more of the bus bars 117. The bus bars 115 are all connected to a positive voltage post 127 and the different bus bars 115 are all connected to a negative voltage post 132. In other embodiments, the set 125 of even-numbered the grid plates 110 could be connected to the negative voltage post 132, via one of the bus bars 115 or different bus bars 117, and, the set 130 of odd-numbered the grid plates 110 could be connected to the positive voltage post 127, via the other one of the bus bars 115 or different bus bars 117.

Grid plates 110 connected to the positive voltage post 127 are designated positive grid plates while grid plates connected to the negative voltage post 132 as designated negative grid plates. One skilled in the art would understand how the grid plates 110 could be composed of different metal or metal alloys (e.g., lead and lead alloys) and include different materials (e.g., reactive battery pastes) to facilitate their use as one of the positive or negative grid plates. One skilled in the art would understand how adjacent grid plates 110 would be separated from each other by conventional separator materials. The outer rims 120 of adjacent grid plates 110 can be insulated so as to prevent positive grid plates and negative grid plates from being shorted.

The term substantially cylindrically-shaped as used herein refers to the general shape of the perimeter of the grid plates 110. Having substantially cylindrical shape of the grid plates 110 permits the stack 105 to fit inside of a cylindrical enclosure 140 of the battery 100 (e.g., a legacy battery can that holds the battery's electrolytes; a partial view of which is depicted in FIG. 1), while still maximizing the surface area of the grid plates 110 and thereby increasing the battery's 100 storage capacity.

Configuring the battery 100 such that the bus bars 115, 117 are located around the perimeter of the grid plates 110 and connected to the plate's outer rims 120 can facilitate the use of common parts, or at least commonly-shaped parts, for several components of the battery 100, thereby reducing battery manufacturing and assembly costs. For instance, in some cases such as shown in FIG. 1 one or more of the bus bars 115, 117, grid plates 110 and multi-armed assembly 145 (connecting the bars 115, 117 to the posts 127, 132) can have common shapes thereby allowing their repeated use as components in the battery 100. For instance, the use of grid plates 110 that all have substantially the same cylindrical-shape facilitates their use as either positive grid plates or negative grid plates in the battery 100. This is in contrast to some round cell battery designs where differently shaped grid plates must be separately fabricated for use as the positive and negative grid plates, respectively.

Although some embodiments of the grid plates 110 could have a continuously curving outer rim 120, in some cases it is desirable for the outer rim 120 to have straight sides. The presence of straight sides can facilitate fabrication processes to couple sides 205 to one of the bus bars 115, 117 (FIGS. 2-3). The presence of straight sides can also facilitate fabrication processes used to cover those sides 205 not contacted to bus bars 115, 117 with an electrical insulating material. For instance, as shown in FIG. 2 the grid plates 110 have a substantially same cylindrical-shape that is a hexagonal-shape, with straight sides 205 that defines the outer rim 120 of each grid plate 110. Although a hexagonal shape is depicted in other embodiments, the substantially cylindrical-shapes of the grid plates 110 could have pentagonal, heptagonal, octagonal, nonagonal, decagonal or higher multi-sided polygonal shapes. In some cases, the grid plates 110 could have an odd number of side, although this can cause an imbalance in the positive and negative poles, e.g., if all of the sides are connected to bus bars 115, 117.

In some cases, it is desirable for each one of the grid plates 110 to have an even number of the straight sides 205 that define the outer rim 120, and, a number of bus bars 115, 117 that is equal to the even number of straight sides 205. For instance, as illustrated in FIGS. 1-2, in the case where the grid plates 110 have a hexagonal-shape, there are six straight sides 205 and six of the bus bars 115, 117. In other embodiments, grid plates 110 with other evenly numbers sides 205 (e.g., octagons, decagons, dodecagons etc. . . . ) could be used, if desired. In some cases, however, hexagonally shaped grid plates 110 are particularly desirable because this shape provides a reasonable compromises between ease of manufacture or the grid plates 110, ease of assembly of the stack 105, and battery performance.

The presence of an even number of straight sides 205 can facilitate the bus bars 115, 117 being uniformly distributed around the stack 105 of grid plates 110. For instance, as shown in FIGS. 1-2, bus bars 115 (or bars 117) can be connected to every other side 205 of one set 125 of grid plates 110 (e.g., positive grid plates) and different bus bars 117 (or bars 115) can be connected to every other side 205 of the other set 125 of grid plates 110 (e.g., negative grid plates). A uniform distribution of bus bars 115, 117 facilitates having a longer battery life. For instance, the greater dimensional isolation between the bus bars 115, 117 that are connected to adjacent grid plates 110 may delay dendrite growth between the adjacent plates 110, thereby delaying the occurrence of electrical shorts. Additionally, having a plurality of bus bars 115, 117 situated equally around, and connected to, each of the grid plates 110 of the stack 105 help to reduce the contact resistance between the bus bars 115, 117 and the grid plates 110, thereby improving battery efficiency.

Having a uniform distribution of bus bars 115, 117 around the stack 105 can also help to mechanically stabilize the stack's 105 position and facilitate its positioning in the battery enclosure 140. For instance, as shown in FIG. 1, in some embodiments, one end of the bus bars 115, 117 can include landing pads 150 that are configured to rest on the floor 152 of the enclosure 140, thereby helping to hold the stack's 105 position away from the floor 152 and walls 154 of the enclosure 140 as well as away from electrolyte sediment that may accumulate on the floor 152. In some cases, the floor 152 can include bosses 156 configured to hold the landing pads 150 securely therein above potential sediment. For instance, as also shown in FIG. 1, in some embodiments, an opposite end of the bus bars 115, 117 can include lift elements 160 (e.g., lifting rings) to facilitate lifting the stack 105 into the battery enclosure 140. A uniform distribution of the bus bars 115, 117 with lift elements 160 can facilitate positioning of the stack 105 centrally in the enclosure 140.

As further shown in FIG. 2 in some cases to facilitate coupling to the bus bars 115, 117, some embodiments of the grid plate 110 further includes one or more tabs 210. FIG. 3 presents a cross-sectional view of an example grid plate 110 of the round cell battery 100 such as presented in FIGS. 1-2, along view line 3-3 in FIG. 2. One end 315 of each of the tabs 210 is connected to the grid plate's 110 outer rim 120 and another end 320 is connected to one of the bus bars (not shown). In some cases, alternate ones of the grid plates 110 (e.g., the grid plates 110 in set 125 or in set 130) in the stack 105 each include at least one tab 210 that is aligned with the other tabs 210 of the alternating ones of the grid plates 110.

In some cases, the tabs 210 can be located on every other of the straight sides 205 of the grid plate 110. As an example, for hexagonal shaped grid plates 110, adjacent grid plates 110 can be rotated by 60 degree such that every other one of the grid plates 110 has a tab 210 that is aligned with alternating grid plates 110 of the stack 105. Straight sides 205 on grid plates 110 that do not have tabs, and, that are adjacent to the sides 205 that do have the tabs 210 can be coated with an insulating material (e.g., an insulating layer 317; for clarity only portions of the layers 317 are depicted in FIG. 3) to electrical isolate the adjacent grid plates 110 (e.g., to isolate negative grid plates from adjacent positive grid plates). For instance, the non-tabs 210 sides of the outer rim 120 can be coated on three sides with an insulating compound such that when the disc are rotated into position in the stack 105, the surface distance between dissimilar plates (e.g., negative and positive plates) is increased. The tabbed 210 side of the outer rim 120 can remain uncoated. This configuration can increase the growth path for shorting dendrites and thereby increased the battery's longevity.

As further illustrated in FIG. 3, in some embodiments, each of the grid plates 110 can have an interior grid pattern 330 configured to hold battery paste (not shown) therein. For instance, pockets 340 of the pattern 330 can be configured to hold the battery paste. One skilled in the art would be familiar with the types of battery paste compositions used in round cell battery applications. In some embodiments, it is desirable for each of the grid plates 110 to have a substantially the same interior grid pattern 310 and in some cases substantially same-sized and same-shaped pockets 310 throughout the grid plate 110. Such configurations facilitate to use of uniformly sized battery paste pellets to be placed in the grid patterns 330. For instance, as shown in FIG. 3, the grid patterns 330 can include triangularly-shaped pockets 340, and in particular, equilateral triangularly-shaped pockets 340. In some cases, to facilitate more securely holding the battery paste pellets, the pockets 340 can include negative relief and locking features.

As further illustrated in FIG. 3, in some embodiments, each of the grid plates 110 can have an interior opening 350 (e.g., central opening) that is configured to provide a common pathway for venting battery gases in the stack 105. To provide a gas venting pathway, the interior opening 350 of each grid plate 110 in the stack 105 preferably is unobstructed. The internal opening 350 can be coated with nonconductive insulator or have grid plate separators. In some cases, the interior opening 350 has a shape that matches the substantially cylindrical-shape of the grid plate 110. For instance, in some cases where the grid plate 110 has a hexagonal shape, the interior opening 350 also has a hexagonal shape.

In some preferred embodiments, the grid plates 110 in the stack 105 have a conical shape (or equivalent domed shape) because this shape facilitates the venting of battery gases. For instance, a sloping angle of the conical shape aids in venting any gases produced through the interior opening 350. Having conically shaped grid plates 110 can also beneficially relieve radial stresses on grid plates 110.

As discussed above in the context of FIG. 1, some embodiments of the battery 100 can include one or more multi-armed assembly 145, each configured to electrically connect the common bus bars (bars 115, or alternatively, bars 117) together and to provide an external connect point for the battery 100 by way of one of the posts 127, 132.

FIG. 4 shows a detailed perspective view of a multi-armed assembly 145 of the battery 100 such as depicted in FIG. 1. In some cases, one of the positive voltage post 127, or the negative voltage post 132, is connected to a multi-armed assembly 145, the positive voltage post 127, or negative voltage post 132, being part of a central hub 410 of the multi-armed assembly 145. The number of arms 420 in the assembly 145 preferably equals the number of bus bars (bars 115, or alternatively, bars 117) connected to any one of the posts 127, 132. For instance, in some cases, such as when using grid plates 110 with a hexagonal shape, there can be three bus bars (e.g., bars 115, or bars 117) coupled to the alternating positive grid plates 110 (e.g., one of the sets 125, 130 of positive or negative grid plats 110) and the three bus bars are all connected to a y-shaped multi-arm assembly 145 having three arms 420. As illustrated in FIG. 1, in some cases, a pair of multi-armed assemblies 145 can be configured so that arms 420 can intertwine in the assemblies 145 to facilitate interconnection of bus bars 115, 117 to the appropriate post 127, 132 without electrically shorting the other post 127, 132. Of course, geometries other than the y-shape can be used in the multi-arm assembly 145. Although FIGS. 1 and 4 depict straight arms 420 in other embodiments, the arms 420 may have an arc, e.g., to accommodate the curve in the grid plates 110 when having a conical shape.

As further illustrated in FIG. 4, in some embodiments the central hub 410 can includes a labyrinth portion 430 located between the arms 420 of the assembly 145 and the positive or negative voltage post 127, 132 of the assembly 145. For instance, FIG. 5 shows a detailed perspective view of a helical labyrinth portion 430 of the multi-armed assembly 145 such as presented in view 5 of FIG. 4. Such embodiments of the battery 100 preferably also include a gasket assembly (not shown) molded to match the shape of the labyrinth portion 430 to thereby deter battery solution leakage from the enclosure 140 by providing a long leakage path. For instance, the gasket assembly can include a rubber convoluted gasket with a serpentine helical labyrinth so as to provide sealing surface to mold to the shape of the helical labyrinth portion 430. The gasket assembly can include epoxy, or other glue, dispersed through a filling port in the gasket, to bond the gasket to the labyrinth portion 430.

Another embodiment of the disclosure is a method of assembling the round-cell battery 100. FIG. 6 presents a flow diagram of an example embodiment of a method 600 of assembling a battery of the disclosure, such as any of the example batteries 100 depicted in FIGS. 1-5. With continuing reference to FIGS. 1-5, the method 600 comprises a step 605 of forming the stack 105 of the substantially cylindrically-shaped electrically conductive grid plates 110.

The method 600 also comprises a step 610 of connecting the two or more bus bars 115, 117 to the outer rims 120 of the grid plates 110. As noted previously in the context of FIG. 1, one or more of the bus bars 115 are connected to the outer rims 120 of the set 125 of alternating ones of grid plates 110 of the stack, and, a different one or more of the bus bars 117 are connected outer rims 120 of different alternating ones of a different set 130 of grid plates 110 of the stack 105.

The method 600 further comprises a step 615 coupling the one or more bus bars (e.g., one of bars 115 or bars 117) to the positive voltage post 127; and a step 620 of coupling different one or more bus bars (e.g., the other of bars 115 or bars 117) to the negative voltage post 132.

In some embodiments, the method 600 can further include a step 630 of providing the grid plates 110. For instance, in some cases, providing the grid plates 110 in step 630 includes casting a mold of substantially same-shaped grid plates 110. This has the advantage of requiring only one mold, or mold design, and one tool or machine to form both the positive and negative grid plates 110. For instance, a molten lead or lead alloy appropriate for positive and negative grid plates can be poured into same-shaped mold and allowed to cure. In other case, however, providing the grid plates 110 in step 630 can include machining or stamping grid plates 110 from precast plates or using other methods apparent to those skilled in the art based upon the present disclosure. In some cases as part of providing the grid plates 110 in step 630, the straight sides 205 of the outer rim 120 and tabs 210 are formed, e.g., as part of a molding, machining or stamping process. In other cases, however, the tabs 210 may be welded or otherwise coupled to the outer rim 120 of the grid plate 110 in a separate step. In some cases the step 630 of providing the grid plates 110 can further include pressing the grid plates 101 into a conical geometry. For instance, the grid plates 110 may be pressed into conical or similar geometry after a molding process to form the grid plates 110.

In some cases, the step 605 of forming the stack 105 includes step 635 stacking the substantially same cylindrically-shaped grid plates 110 such that straight sides 205 of the outer rims 120 of the grid plates 110 are aligned with each other. For instance, in the case where the grid plates 110 are hexagonally shaped the successive grid plates 110 in the stack can be rotated by 60 degree as they are added to the stack 105 such that alternate one of grid plates 110 of the stack have their tabs 205 aligned. The sides 205 not configured to connected to the bus bars 115, 117 (e.g., sides 205 without tabs 205 attached thereto) can be coated in step 637 with an insulating material (e.g., insulating layer 317, FIG. 3), e.g., by spray or dip coating. In some cases, all of the sides 205 can be coated with the tab 210 covered so that they are not also coated.

One skilled in the art would appreciate that forming the stack in step 605 could include additional steps to complete the stack, such as: filling pockets 340 of the grid plates 110 with a battery paste; providing battery separator material (e.g., one or more of polymer mesh thermally bonded to a polyethylene grid/structure, fiberglass matting, or, foam materials) between adjacent grid plates 110; and covering portions of the grid plates with insulating material (e.g., polyethylene insulators) to help retard shorting electrolytic growth of oxides of lead.

In some cases, the step 610 of connecting the bus bars 115, 117 to the outer rims 120 of the grid plates 110 can include a step 640 of dipping the stack 105 into a mold such that a portion of the outer rims 120 (e.g., one of the aligned straight sides 205 of the outer rim 120) contacts a molten conductive material (e.g., molten lead or a lead alloy), and, a step 645 of curing the molten conductive material until it solidifies to thereby form one of the bus bars 115, 117. The stack can then be rotated in step 650 (e.g., 60 degrees for hexagonally shaped grid plates 110) and steps 640 and 645 repeated until all of the bus bars 115, 117 are formed and connected to different sides 205 of the stack 105.

In some embodiments coupling the bus bars 115, 117 to the positive voltage post 127 or negative voltage post 132 (steps 615, 620, respectively) can further include connecting the bus bars 115, 117 to one or more multi-arm assemblies 145 that includes the positive and negative posts 127, 132 (steps 660, 662, respectively). The method 600 can also include a step 670 of installing a gasket around a labyrinth portion 430 of the multi-arm assembly 145, which can include of sealing the gasket into place around the labyrinth portion 430.

Embodiments of the method 600 can further include a step 680 of positioning the stack 105 and connected bus bars 115, 117 into an enclosure 140 of the battery 100. For instance, the stack 105 and bus bars 115, 117 can be lifted via lift elements 160 on the ends of the bus bars 115, 117 and placed in a cylindrically-shape metal or plastic enclosure.

Although the embodiments have been described in detail, those of ordinary skill in the art should understand that they could make various changes, substitutions and alterations herein without departing from the scope of the disclosure.

What is claimed is:

1. A round-cell battery, comprising:
a stack of substantially cylindrically-shaped electrically conductive grid plates; and
two or more bus bars, wherein
one or more of said bus bars is electrically connected to outer rims of a set of alternating ones of said grid plates in said stack and to a positive voltage post of said battery, and
a different one or more of said bus bars is electrically connected to outer rims of a different set of alternate ones of said grid plates in said stack and to a negative voltage post of said battery.

2. The battery of claim 1, wherein each of said grid plates have a substantially same cylindrical-shape with straight sides that defines said outer rim of each of said grid plates.

3. The battery of claim 1, wherein each one of said grid plates has an even number of straight sides that define said outer rim of said grid plate and a number of said bus bars that is equal to said even number of straight sides.

4. The battery of claim 3, wherein said substantially cylindrically-shape is a hexagonal-shape, there are six of said even number of straight sides, and there are six of said bus bars.

5. The battery of claim 1, wherein said bus bars are uniformly distributed around said stack.

6. The battery of claim 1, wherein said grid plates further includes one or more tabs, one end of each of said tabs connected to said outer rim and another end is connected to one of said bus bars.

7. The battery of claim 6, wherein said alternate ones of said grid plates in said stack each include at least one of said tabs that is aligned with other said tabs of said alternating ones of said grid plates.

8. The battery of claim 6, wherein sides of said outer rim not having said tabs are coated with an insulating layer and sides of said outer rim having said tabs are not coated with said insulating layer.

9. The battery of claim 1, wherein each of said grid plates have an interior grid pattern configured to hold battery paste therein.

10. The battery of claim 9, wherein each of said grid plates have a substantially same said interior grid pattern.

11. The battery of claim 9, wherein said interior grid pattern has substantially same-sized pockets throughout said grid plate.

12. The battery of claim 11, wherein said pockets have a triangular shape.

13. The battery of claim 1, wherein each of said grid plates includes an interior opening configured to provide a common pathway for venting battery gases in said stack.

14. The battery of claim 1, wherein said bus bars electrically coupled to one of said positive voltage post or said negative voltage post are connected to a multi-armed assembly, said positive voltage post or said negative voltage post being part of a central hub of said multi-armed assembly.

15. The battery of claim 14, wherein said central hub includes a labyrinth portion located between arms of said multi-armed assembly and said positive or negative voltage post.

16. A method of assembling the round-cell battery of claim 1, comprising:
forming said stack of said substantially cylindrically-shaped electrically conductive grid plates;
connecting said two or more bus bars to said outer rims of said grid plates;
coupling said one or more bus bars to said positive voltage post; and
coupling said different one or more bus bars to said negative voltage post.

17. The method of claim 16, further including providing grid plates including casting a mold of substantially same shaped said grid plates.

18. The method of claim 17, wherein forming said stack includes stacking substantially same cylindrically-shaped grid plates such that straight sides of said outer rims of said grid plates are aligned with each other.

19. The method of claim 16, wherein connecting said two or more bus bars to said outer rims includes dipping said stack into a mold such that a portion of said outer rims contacts a molten conductive material and cure said molten conductive material to thereby form one of said bus bars.

20. The method of claim 16, wherein coupling said bus bars to one of said positive voltage post or said negative voltage post, includes connecting said bus bars to one or more multi-arm assemblies that includes one of said positive post or said negative post.
